(19) United States
(12) Patent Application Publication
(10) Pub. No.: US 2001/0025429 A1
(43) Pub. Date: Oct. 4, 2001

(54) Crate dryer

(76) Inventors: Gerritt Middelkoop, Ln Strijen (NL); Johannes C. Andeweg, Se Numansdorp (NL)

Correspondence Address: George M. Thomas, THOMAS, KAYDEN, HORSTEMEYER & RISLEY, LLP, Suite 1500, 100 Galleria Parkway N.W., Atlanta, GA, 30339-5948, US

(21) Appl. No.: 09/805,270

(22) Filed: Mar. 13, 2001

(30) Foreign Application Priority Data
Mar. 15, 2000 (NL) 1014651

(51) Int. Cl. F26B 17/24

(52) U.S. Cl. 34/58

(57) ABSTRACT

Device for drying washed and rinsed crates or cases, comprising a frame and receiving or accommodation spaces carried by the frame for the crates or cases, in which the accommodation spaces are attached to a rotating shaft and are situated on either side of it in a symmetrical manner, and furthermore comprising means for rotating the rotating shaft and thus the accommodation spaces in order to cast off the water present on the crates or cases from them through centrifugal forces.

### FIELD OF THE INVENTION

The invention relates to a device for drying washed and rinsed crates or cases.

### DESCRIPTION OF THE RELATED ART

Crates and cases are used by the wholesaler, auction hall, factory and the like for containing and transporting all sorts of products. After the products have been sold at the retailer's the crates are returned. The crates are then washed in order to be used again.

In the course of time the wish arose to have disposal of not only cleansed, but also dry crates. To that end various dryers have been thought up, such as compressed-air-operated blowers. A drawback of this however is that for a quick treatment of the crates to be dried a lot of so-called flat-air-blasting nozzles are necessary and therefore a lot of (expensive) compressed air.

Alternatively high-pressure fans are also used, which however requires a high power, otherwise the drying capacity is to limited.

Shake devices are also used, but still quite a lot of attached water is left behind on the crates.

Crates are also dried with the help of hot air, in connection with fans. The crates are often made of synthetic material, as a result of which they do not absorb heat very well and the drying process takes quite a long time.

Another alternative is drying crates with the help of infrared radiation, but here again there is the drawback that the crates are made of synthetic material and therefore do not conduct heat very well.

Finally the drying of crates under vacuum is mentioned. The advantage of this is that a lower temperature can be worked with, but a drawback is that special—and therefore expensive—measures have to be taken in order to realise a vacuum surrounding.

### SUMMARY OF THE INVENTION

It is an object of the invention to improve on this. To that end the invention provides a device for drying washed and rinsed crates or cases, comprising a frame and receiving or accommodation spaces carried by the frame for the crates or cases, in which the accommodation spaces are attached to a rotating shaft and are situated on either side of it in a symmetrical manner, and furthermore comprising means for rotating the rotating shaft and thus the accommodation spaces in order to cast off the water present on the crates or cases from them through centrifugal forces.

By using centrifugal forces the crates can be dried quickly with simple equipment. It is noted here that it is known per se to rotate crates quickly in order to dry them, but a vertical stack of crates is then rotated about the stack axis, during which imbalance may occur and the centrifugal forces often turn out to be insufficient.

Preferably the rotating shaft is horizontally positioned. This facilitates connection to supply and discharge devices for the crates to and out of the drying device, respectively, preferably parallel to its rotating shaft.

Preferably the accommodation spaces have boundaries that are adjustable in distance one to the other, so that a positive placement in the accommodation spaces can be realised for either various heights or widths between sets of crates.

The crates are kept in their places in a simple manner when the boundaries of the accommodation spaces comprise angle sections destined for engaging about the longitudinal edges of the crates.

Preferably the device is furthermore provided with a screen stationary with the frame for radially outward stopping of the water cast off from the crates, and with a collection tray for water intercepted by the screen.

From another aspect the invention provides an assembly of a device according to the invention and a supply device for crates to be dried and/or discharge device for dried crates, in which either the supply device or discharge device is in line with or can be brought in line with at least one accommodation space.

### BRIEF DESCRIPTION OF THE DRAWINGS

The invention will be elucidated on the basis of the exemplary embodiment shown in the attached figures, in which:

FIG. 1 shows a front view on a crate dryer according to the invention;

FIG. 2 shows a top view on the crate dryer of FIG. 1; and

FIG. 3 shows a side view on the crate dryer of FIGS. 1 and 2.

### DETAILED DESCRIPTION OF THE DRAWINGS

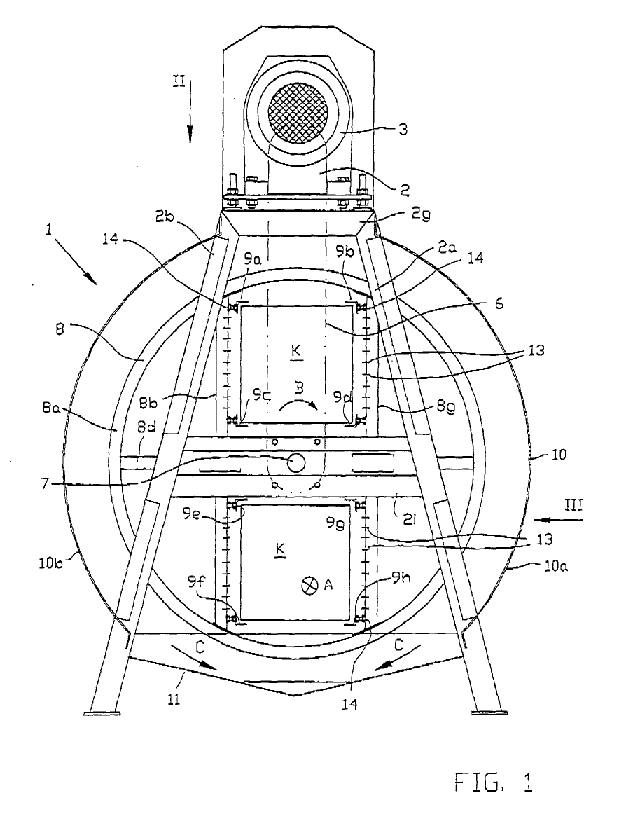

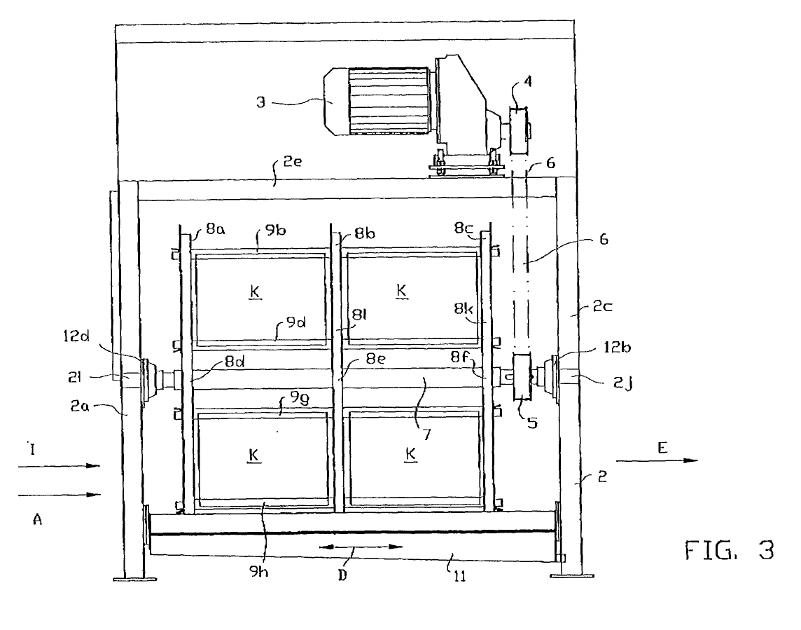

The crate dryer 1 of the FIGS. 1-3 comprises a frame 2, which at the front and at the rear comprises substantially A-shaped upright frames, having braces 2a, 2b and 2c, 2d, respectively, upper transverse beams 2g and 2h, respectively, and middle transverse beams 2i and 2j (not directly shown), respectively.

On top of the frame 2 an electric motor 3 has been mounted, with which a toothed belt pulley 4 is driven, over which toothed belt pulley 4 a toothed belt 6 runs which makes the toothed belt pulley 5 that is situated below rotate. The toothed belt pulley 5 is situated at the end of a rotating shaft 7, which on both sides is journalled in bearings 12a, 12b that are attached to the middle transverse beams 2I and 2J of the frame 2.

The rotating shaft 7 is attached to a drum 8, which is formed by an open frame, comprising a front ring 8a, a middle ring 8b, and a rear ring 8c. For each ring 8a-8c a transverse beam 8d is provided, with which the ring is attached to the rotating shaft 7. Furthermore posts 8g, 8h, 8i, 8j and 8k, 8l that are also connected to the rings 8a-8c, have each time been arranged in pairs extending upward and downward from the transverse rods 8d, 8e, 8f.

The posts 8g-8l are provided with holes 13, in which bolt connections 14 may extend, with which bolt connections 14 angle sections 9a-9h can be attached to the posts 8g-8l, at the wanted level.

Said wanted level depends on the height of the crates K that have to be dried in the device 1.

Around the drum 8 a screen 10 has been arranged, of which the circular shells 10a, 10b can clearly be seen in FIG. 1. Below the drum a drip tray 11 is situated, on which the water can run off in the direction C in transverse direction and subsequently in the direction D in longitudinal direction, to a location of discharge that is not further shown.

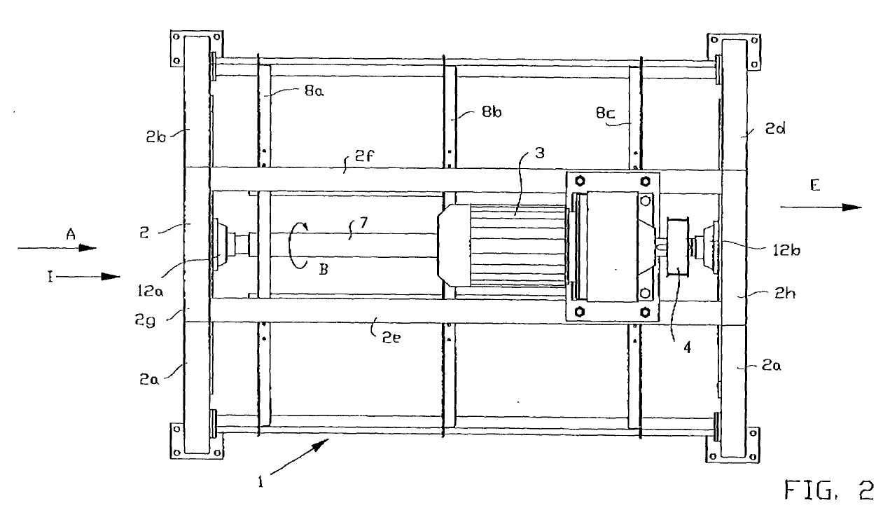

When washed and dried crates have to be dried they are supplied in the direction A with means that are not shown to the drying device, and they are inserted into the bottom compartment, in FIG. 1 formed by angle sections 9e-9h. In this example two crates after another can be inserted. The angle sections 9e-9h here engage about the longitudinal edges of the crate K. Subsequently the drum 8 is rotated over 180°, in order to bring the other compartments in front of the supply of crates. Two crates—in this example—are then inserted into it again, which crates then are kept confined by the angle sections 9a-9d. The drum, loaded with crates entirely on either side of the rotating shaft 7, is then balanced. The drum is subsequently rotated with such speed that the centrifugal force is sufficient to throw the water off from the crates. As soon as this speed is reached, the drum is slowed down again. As soon as the drum has come to a standstill again, the centrifuged crates are moved out of the drum, in the direction E (see FIG. 2). As a result emptying the compartments can take place simultaneously with filling the same compartments, from the direction A. As a result operation time is saved on.

It will be understood that the capacity of the drum may be increased by making it longer and/or larger in diameter.

Another option is placing several drying devices 1 adjacent to each other and having them alternatingly operative such that the one device is loaded/unloaded and other is rotated.

1. Device for drying washed and rinsed crates or cases, comprising a frame and receiving or accommodation spaces carried by the frame for the crates or cases, in which the accommodation spaces are attached to a rotating shaft and are situated on either side of it in a symmetrical manner, and furthermore comprising means for rotating the rotating shaft and thus the accommodation spaces in order to cast off the water present on the crates or cases from them through centrifugal forces.

2. Device according to claim 1, in which the rotating shaft is horizontally positioned.

3. Device according to claim 1, in which the accommodation spaces have boundaries that are adjustable in distance one to the other.

4. Device according to claim 3, in which the boundaries of the accommodation spaces comprise angle sections destined for engaging about the longitudinal edges of the crates.

5. Device according to claim 1, provided with a screen stationary with the frame for radially outward stopping of the water cast off from the crates.

6. Device according to claim 5, provided with a collection tray for water intercepted by the screen.

7. Device according to claim 1, in which the device is provided with a crate feed that opens parallel to the rotating shaft.

8. Device according to claim 1, in which the device is provided with a crate exit that opens parallel to the rotating shaft.

9. Assembly of a device according to claim 7 and a supply device for crates to be dried/or discharge device for dried crates, in which either the supply device or discharge device is in line with or can be brought in line with at least one accommodation space.
